(19) United States
(12) Patent Application Publication
(10) Pub. No.: US 2005/0062572 A1
(43) Pub. Date: Mar. 24, 2005

(54) Permanent magnet alloy for medical imaging system and method of making

(75) Inventors: Judson Sloan Marte, Wynantskill, NY (US); Juliana Chiang Shei, Niskayuna, NY (US); Mark Gilbert Benz, Lincoln, VT (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/666,697

(22) Filed: Sep. 22, 2003

(51) Int. Cl. H01F 5/00

(52) U.S. Cl. 335/299

(57) ABSTRACT

A composition of matter suitable for use as a permanent magnet includes a rare earth-transition metal-boron alloy, where at least 30 weight percent of the rare earth content of the alloy comprises Pr, at least 50 weight percent of the transition metal content of the alloy comprises Fe, and the alloy contains less than 0.6 weight percent oxygen.

### BACKGROUND OF THE INVENTION

The present invention is directed generally to magnet compositions and more particularly to transition metal-rare earth-boron magnet compositions.

Some magnetic resonance imaging (MRI) systems utilize high purity permanent magnets, such as Nd—Fe—B permanent magnets which exhibit sufficient remanence, coercivity and energy product for MRI application. To improve corrosion resistance, 0.6 weight percent or greater of oxygen, such as 0.6 to 1.2 weight percent of oxygen may be added to the magnet, as described in A. S. Kim et al., IEEE Transactions of Magnetics, 26 (5) (1990) 1936. While this high amount of oxygen improves corrosion resistance of the magnet, it deleteriously affects the ratio of Nd to Fe, thereby degrading the desired magnetic properties. In contrast, rare earth-iron-boron (RE-M-B) permanent magnet alloys containing less than 0.6 weight percent oxygen have a significantly lower corrosion resistance than alloys containing 0.6 or greater weight percent oxygen content, as described in U.S. Pat. No. 4,588,439.

### BRIEF SUMMARY OF THE INVENTION

A preferred embodiment of the present invention provides a composition of matter suitable for use as a permanent magnet comprising a rare earth-transition metal-boron alloy, wherein at least 30 weight percent of the rare earth content of the alloy comprises Pr, at least 50 weight percent of the transition metal content comprises Fe, and the alloy contains less than 0.6 weight percent oxygen.

Another preferred embodiment of the present invention provides a magnetic resonance imaging (MRI) system, comprising a yoke having a first portion, a second portion and at least one third portion connecting the first and the second portions such that an imaging volume is formed between the first and the second yoke portions. A first magnet assembly is attached to the first yoke portion and a second magnet assembly is attached to the second yoke portion. The first magnet assembly comprises a first permanent magnet body comprising a rare earth-transition metal-boron alloy, where at least 30 weight percent of the rare earth content of the alloy comprises Pr, at least 50 weight percent of the transition metal content of the alloy comprises Fe, and the alloy contains less than 0.6 weight percent oxygen. The first permanent magnet body has a first surface and a stepped second surface facing the imaging volume. At least one first layer of soft magnetic material is located between the first yoke portion and the first surface of the first permanent magnet body.

Another preferred embodiment of the present invention provides a method of making an MRI device, comprising providing a yoke having a first portion, a second portion and at least one third portion connecting the first and the second portions such that an imaging volume is formed between the first and the second yoke portions, attaching a first precursor body to the first yoke portion and attaching a second precursor body to the second yoke portion. The method further comprises magnetizing the first precursor body to form a first permanent magnet body after the step of attaching the first precursor body, and magnetizing the second precursor body to form a second permanent magnet body after the step of attaching the second precursor body. The first and the second precursor bodies comprise a rare earth-transition metal-boron alloy, wherein at least 30 weight percent of the rare earth content of the alloy comprises Pr, at least 50 weight percent of the transition metal content of the alloy comprises Fe, and the alloy contains less than 0.6 weight percent oxygen.

Another preferred embodiment of the present invention provides a method of making a permanent magnet comprising providing a rare earth-transition metal-boron alloy precursor powder, compressing the precursor powder into a green body while applying a magnetic field, compacting and sintering the green body to form a sintered intermetallic block, and magnetizing the sintered intermetallic block to form a permanent magnet block comprising a rare earth-transition metal-boron alloy. At least 30 weight percent of the rare earth content of the alloy comprises Pr, at least 50 weight percent of the transition metal content of the alloy comprises Fe, and the alloy contains less than 0.6 weight percent oxygen.

Another preferred embodiment of the present invention provides a method of making a motor or a generator device, comprising providing a motor or a generator device, attaching a first precursor body comprising at least one unmagnetized alloy block to the device, and magnetizing the at least one unmagnetized alloy block to form a first permanent magnet body after the step of attaching the first precursor body.

### BRIEF DESCRIPTION OF THE DRAWINGS

FIGS. 1-3 are side cross sectional views of a method of making a precursor body according to the second preferred embodiment of the present invention.

FIG. 4 is a perspective view of an exemplary permanent magnet body according to the first preferred embodiments of the present invention.

FIG. 5 is a side cross sectional view of a device used to magnetize a permanent magnet mounted in an MRI system according to the second preferred embodiment of the present invention.

FIG. 6 is a perspective view of the device of FIG. 5.

FIG. 7 is a perspective view of an MRI system containing a “C” shaped yoke.

FIG. 8 is a side cross sectional view of an MRI system containing a yoke having a plurality of connecting bars.

FIG. 9 is a side cross sectional view of an MRI system containing a tubular yoke.

### DETAILED DESCRIPTION OF THE PREFERRED EMBODIMENTS

The present inventors have discovered that rare earth-transition metal-boron permanent magnet alloys have a high corrosion resistance when these alloys have a praseodymium (Pr) rich content and a low oxygen content below 0.6 weight percent. These Pr rich permanent magnet alloys exhibit acceptable remanence, coercivity and energy products for use in an MRI system and in other applications while remaining highly resistant to corrosion/oxidation under ambient conditions for long periods of time, this increasing their usable shelf life. For example, the Pr rich, low oxygen content permanent magnet alloy is capable of remaining substantially corrosion free for at least four years at atmospheric ambient in an uncoated state. A Pr rich permanent magnet alloy is an alloy where at least 30 weight percent of the rare earth content of the alloy comprises Pr. Preferably, at least 50 atomic percent of the rare earth content of the alloy comprises Pr.

In a preferred aspect of the present invention, a composition of matter suitable for use as a permanent magnet comprises a rare earth-transition metal-boron alloy, where at least 30 weight percent of the rare earth content of the alloy comprises Pr, at least 50 weight percent of the transition metal content comprises Fe, and the alloy contains less than 0.6 weight percent oxygen. Preferably, the alloy contains greater than zero but less than 0.6 weight percent oxygen. Most preferably, the alloy contains between about 0.1 and about 0.2 weight percent oxygen. In terms of atomic percent oxygen, the alloy preferably contains about 0.04 to about 0.08 atomic percent oxygen. The composition of matter suitable for use as a permanent magnet described above may comprise a magnetized permanent magnet or an unmagnetized precursor composition which is adapted to be a permanent magnet when magnetized, as will be described in more detail below.

The rare earth-transition metal-boron alloy preferably comprises in atomic percent a RE₁₃₋₁₉B₄₋₂₀M₆₁₋₈₃ alloy with the balance impurities and oxygen, where RE is one or more rare earth elements and M is one or more transition metals. In other words, the praseodymium rich Re-M-B alloy preferably comprises about 13 to about 19 atomic percent of one or more rare earth elements (preferably about 13 to about 17 percent), where the rare earth content is greater than 50 atomic percent praseodymium, an effective amount of a light rare earth elements selected from the group consisting of cerium, lanthanum, yttrium and mixtures thereof, and balance neodymium; about 4 to about 20 atomic percent boron; and about 61 to about 83 atomic percent transition metal, of which at least 50 atomic percent is iron; less than 0.6 weight percent oxygen; and optionally containing unavoidable impurities and/or additional alloying elements. For example, the alloy may contain 13.45 atomic percent RE, 74.4 atomic percent Fe and 5.6 atomic percent B, less than 0.6 weight percent oxygen and 3 weight percent or less of other alloying elements and unavoidable impurities. However, other composition ranges may also be used. For example, the rare earths may comprise more than 19 atomic percent of the alloy, such as 20 to 26 atomic percent of the alloy.

Preferably, the percent praseodymium of the rare earth content is at least 70 atomic percent and can be up to 100 atomic percent depending on the effective amount of light rare earth elements present in the total rare earth content. More preferably, the rare earth content comprises about 50 to about 90 atomic percent Pr, about 9.5 to about 45 atomic percent Nd and about 0.5 to about 5 atomic percent Ce. If desired, the light rare earth elements may be omitted (i.e., zero atomic percent or present as unavoidable impurity content) or be present up to 10 atomic percent and the Nd content may vary from about 10 to about 50 atomic percent of the total rare earth content.

Preferably, the iron comprises between about 75 and about 100 atomic percent of the total amount of transition metal in the alloy. More preferably, the transition metal comprises between about 80 and about 99 atomic percent Fe and between about 0.5 to about 20 atomic percent Co, such as between about 85 and about 95 atomic percent Fe and between about 5 and about 15 atomic percent Co.

Preferably, the alloy, such as an isotropic alloy, comprises at least 80 weight percent of a RE₂Fe₁₄B magnetic phase having a tetragonal crystal structure, more preferably between 90 and 100 weight percent of the magnetic phase. The alloy may optionally comprise other magnetic and non-magnetic phases in addition to the RE₂Fe₁₄B phase.

The permanent magnet alloy should not be considered limited by the above exemplary compositions. In addition to iron and cobalt, the transition metal may comprise other optional elements, such as, but not limited to, titanium, nickel, bismuth, vanadium, niobium, tantalum, chromium, molybdenum, tungsten, manganese, aluminum, germanium, tin, zirconium, hafnium, and mixtures thereof. Preferably, these other metal elements comprises less than 10 atomic percent, more preferably less than 5 atomic percent of the transition metal content of the alloy.

If desired, heavy rare earth elements may also optionally be present in the alloy. Heavy rare earths include elements selected from the group consisting of dysprosium, gadolinium, samarium, ytterbium, terbium, holmium and mixtures thereof. Preferably, less than one percent of the total rare earth content, such about 0.2 to 0.9 atomic percent, comprises the heavy rare earth elements. If desired, other alloying elements and unavoidable impurities may also be present in the alloy. For example, carbon and/or nitrogen may also optionally be present in the alloy. Preferably, carbon and nitrogen comprise less than 0.1 weight percent of the alloy, such as less than 0.05 weight percent of the alloy.

The RE-M-B alloy described above may be formed by any suitable method into alloy blocks. In one preferred embodiment of the present invention, the alloy block is magnetized prior to being attached to a yoke portion of an imaging system, such as an MRI system. For example, in this preferred embodiment of the invention, a precursor alloy is prepared by arc-melting or induction melting the iron, boron and rare earth metal together in the proper amounts under a substantially inert atmosphere such as argon and allowing the melt to solidify. A suitable amount of oxygen may be incorporated into the precursor alloy either from the ambient or by using an oxygen containing raw material. Preferably the melt is cast into an ingot.

If the isotropic material (alloy) exists as an ingot, then it can be converted to particulate form by any suitable method, such as crushing or pulverizing in order to form the particulate or powder precursor material, such as crushing by mortar and pestle and then pulverizing to a finer form by jet milling. Such powder may also be produced by ball milling or Alpine jet milling.

A magnetic field is then applied to the precursor powder during compression into a green body. A magnetic field of least 7 kOe, preferably about 10 to about 30 kOe may be used. During the application of the magnetic field, the particulate grains align themselves magnetically so that the principal magnetic phase is RE₂Fe₁₄B and the grains magnetically align along their easy axis.

The resulting green body is compressed or compacted by any suitable method, such as by hydrostatic pressing or methods employing steel dies. The green body is then sintered to produce a sintered intermetallic block of desired density. Preferably, the green body is sintered to produce a sintered intermetallic block wherein the pores are substantially non-interconnecting. Any suitable sintering temperature may be used. The sintering temperature depends largely on the alloy composition that is selected and the particle size. For example, the sintering temperature may be in the range of about 950 to about 1200° C. and the sintering time between one and five hours. The density of the sintered intermetallic block may vary, but is preferably 80 up to 100 percent, such as 87 percent or greater. If desired, the sintered intermetallic block is optionally heat-aged at a temperature within 400° C. below its sintering temperature and preferably within 300 to 100° C. below its sintering temperature. The resulting intermetallic block is magnetized, and then attached to the yoke plate of the imaging system without magnetization.

If desired, the sintered block may be initially cooled to room temperature and then heated up to the proper heat-aging temperature. If desired, the sintered bulk intermetallic block can be crushed to a desired particle size, preferably a powder, which is particularly suitable for alignment and matrix bonding to give a stable permanent bonded magnet. Thus, if desired, the permanent magnet is prepared by the dry powder metallurgy method without storing the precursor powder in a solvent or oil prior to pressing and magnetization.

In a second preferred embodiment of the present invention, the intermetallic blocks are magnetized after they are provided into their final end use device, such as after the intermetallic blocks are attached to a yoke of an MRI system.

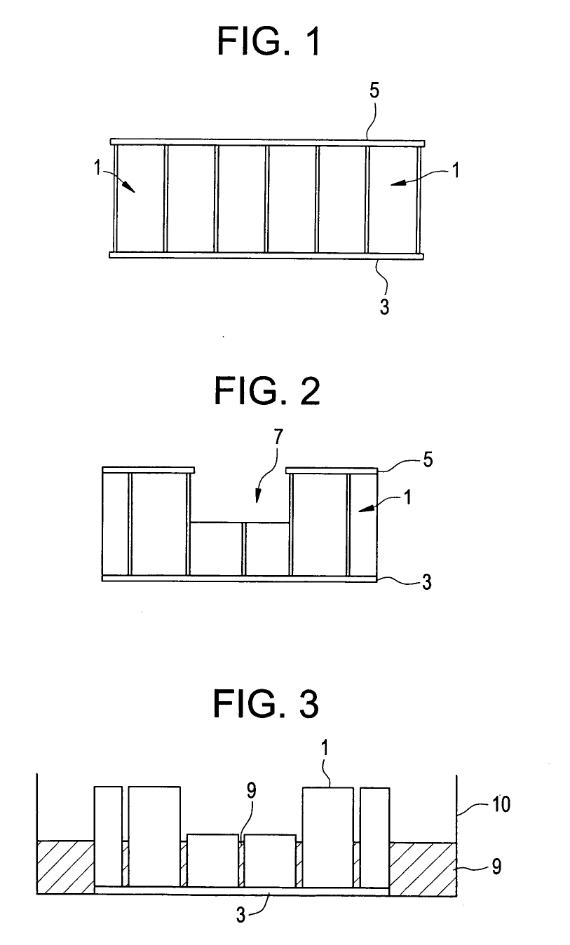

The method of making a permanent magnet body according to the second preferred embodiment will now be described. Preferably, in this embodiment, the precursor body is magnetized after assembly onto the MRI yoke. A plurality of blocks 1 of unmagnetized (totally or partially magnetized) material, such as the Pr rich RE-M-B alloy containing less than 0.6 weight percent oxygen, are assembled on a support 3, as shown in FIG. 1. Preferably, the support 3 comprises a non-magnetic metal sheet or tray, such as a flat, 1/16 inch aluminum sheet coated with a temporary adhesive. However, any other support may be used. A cover 5, such as a second aluminum sheet covered with a temporary adhesive, is optionally placed over the blocks 1.

The assembled blocks 1 are then shaped to form a first precursor body 7 prior to removing the cover 5 and the support 3, as shown in FIG. 2. The assembled unmagnetized blocks 1 are shaped or machined by any desired method, such as by a water jet. The first precursor body 7 may be shaped into a disc, ring, or any other desired shape suitable for use in any suitable device, such as a motor, a generator or an imaging system, for example, an MRI system. Since the precursor body 7 is unmagnetized, it may be readily machined into a desired shape without significant concern about safety or concern that it would become demagnetized during machining. The post assembly shaping or machining thus allows for safe assembly and for improved field homogeneity and reduced shimming time.

The cover sheet 5 is then removed and an adhesive material 9 is provided to adhere the blocks 1 of the precursor body 7 to each other, as shown in FIG. 3. For example, the shaped blocks 1 attached to the support sheet 3 are placed into an epoxy pan 10, and an epoxy 9, such as Resinfusion 8607 epoxy, is provided into the gaps between the blocks 1. If desired, sand, chopped glass or other filler materials may also be provided into the gaps between blocks 1 to strengthen the bond between the blocks 1. Preferably, the epoxy 9 is poured to a level below the tops of the blocks 1. The support sheet 3 is then removed. Alternatively, while less preferred, the assembled blocks 1 may be shaped, such as by a water jet, after being bound with epoxy 9.

Furthermore, if desired, release sheets may be attached to the exposed inside and outside surfaces of the block assemblies prior to pouring the epoxy 9. The release sheets are removed after pouring the epoxy 9 to expose bare surfaces of the blocks 1. If desired, a glass/epoxy composite may be optionally wound around the outside diameters of the assembled blocks to 2-4 mm, preferably 3 mm, for enhanced protection.

In the second preferred embodiment of the present invention, the permanent magnet body comprises at least two laminated sections. Preferably, these sections are laminated in a direction perpendicular to the direction of the magnetic field (i.e., the thickness of the sections is parallel to the magnetic field direction). Most preferably, each section is made of a plurality of square, hexagonal, trapezoidal, annular sector or other shaped blocks adhered together by an adhesive substance. An annular sector is a trapezoid that has a concave top or short side and a convex bottom or long side.

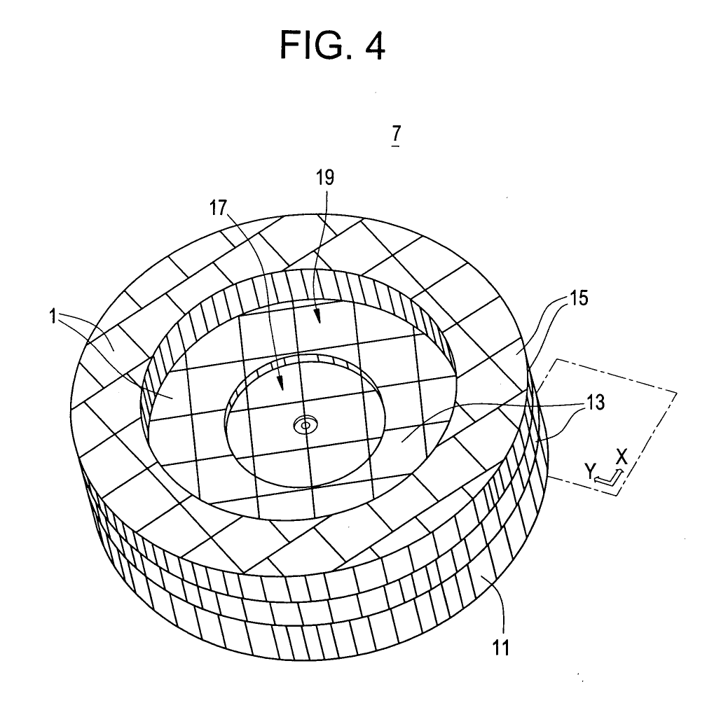

One preferred configuration of the body 7 is shown in FIG. 4. The body 7 comprises a disc shaped base section 11, a ring shaped top section 15 and an optional intermediate section 13. The top section 15 is formed over a major surface of the base section 11. The intermediate section 13 is also disc shaped and contains a cavity 17 which is aligned with the opening 19 in the top section to provide a stepped surface which is adapted to face an imaging volume of an imaging system. Each of the sections 11, 13 and 15 may be made from blocks 1 according to the method shown in FIG. 1-3.

After the sections 11, 13 and 15 shown in FIG. 4 are formed, they are attached to each other by providing a layer of adhesive between them. The adhesive layer may comprise epoxy with sand and/or glass or CA superglue. It should be noted that the permanent magnet body 7 may have any desired configuration other than shown in FIG. 4, and may have one, two, three or more than three sections. Preferably, the bodies 11, 13 and 15 are rotated 15 to 45 degrees, most preferably about 30 degrees with respect to each other, to interrupt continuous epoxy filled channels from propagating throughout the entire structure.

The precursor body 7 is then magnetized to form a permanent magnet body after the unmagnetized blocks 1 are assembled, machined and adhered. The precursor body may be magnetized before being mounted into a device, such as a motor, a generator or an imaging system. However, in a preferred aspect of the second embodiment, the precursor body is magnetized after it is attached to an end use device, such as a motor, a generator or an imaging system. A precursor body having any suitable alloy composition, including the high Pr and low oxygen content RE-M-B alloy described herein as well as other suitable alloys, may be magnetized after the precursor body is attached to the end use device, such as the motor or the generator. In a preferred aspect of the second embodiment, the precursor body is attached to support of an imaging system, such as a yoke of an MRI system.

The unmagnetized material of the precursor body may be magnetized by any desired magnetization method after the precursor body or bodies is/are attached to the end use device, such as a motor, a generator or a MRI yoke or support. For example, the preferred step of magnetizing the first precursor body comprises placing a coil around the first precursor body, applying a pulsed magnetic field to the first precursor body to convert the unmagnetized first precursor body into a first permanent magnet body, and removing the coil from the first permanent magnet body.

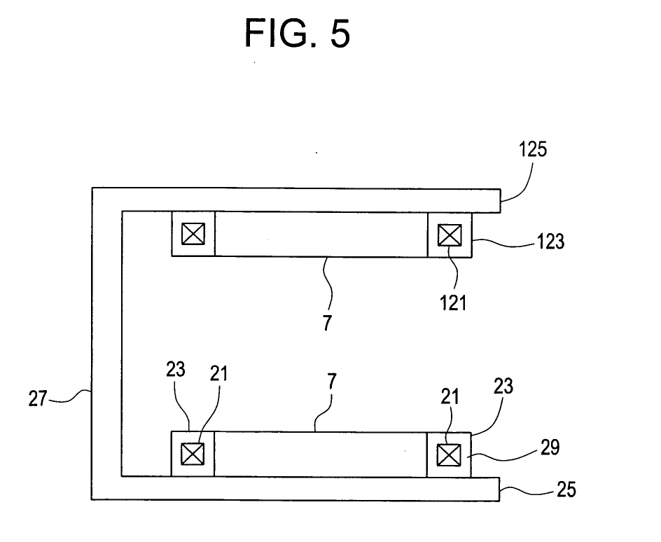

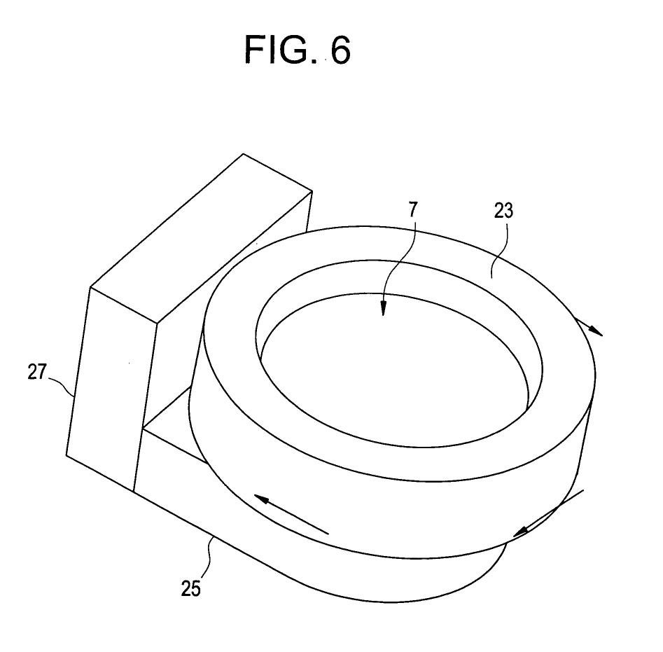

Preferably, the coil 21 that is placed around the precursor body 7 is provided in a housing 23 that fits snugly around the precursor body 7, as shown in FIGS. 5 and 6. The precursor body 7 is located on a portion 25 of a support of an end use device, such as a motor, a generator, or an imaging system, such as an MRI system. For example, the support may comprise a yoke 27 of an MRI system, as shown in FIGS. 5 and 6. For example, for a precursor body 7 having a cylindrical outer configuration, the housing 23 comprises a hollow ring whose inner diameter is slightly larger than the outer diameter of the precursor body 7. The coil 21 is located inside the walls of the housing 23, as shown in FIG. 5.

Preferably, a cooling system is also provided with the housing 23 to improve the magnetization process. For example, the cooling system may comprise one or more cooling fluid flow channels 29 inside the walls of the housing 23. The cooling fluid, such as liquid nitrogen, is provided from a cooling fluid reservoir or tank (not shown in FIGS. 5 and 6) through the channels 29 during the magnetization step. Preferably, a directional magnetic field above 1.5 Tesla, most preferably above 2.0 Tesla, is provided by the coil to magnetize the unmagnetized material of the precursor body or bodies. The housing 23 containing the coil 21 is removed from the imaging system after the permanent magnet is magnetized.

If the imaging system, such as an MRI system, contains more than one permanent magnet precursor bodies, then such precursor bodies may be magnetized simultaneously or sequentially. For example, as shown in FIG. 5, two or more housings 23, 123 containing coils 21, 121 may be used to simultaneously magnetize two precursor bodies 7 that are attached to opposite yoke 27 portions 25, 125. Alternatively, one housing 23 containing the coil 21 may be sequentially placed around each precursor body 7 of the imaging system to sequentially magnetize each precursor body. If optional pole pieces are present in the MRI system, then the precursor bodies 7 may be magnetized before or after placing pole pieces into the MRI system.

In a preferred aspect of the second embodiment, the magnetization of the permanent magnet precursor bodies in an imaging system may be stabilized by applying a recoil pulse to the permanent magnet after it is magnetized. Thus, a precursor body having a shape suitable for use in an imaging system is first magnetized by applying a pulsed magnetic field having a first magnitude and a first direction to the precursor body to convert the precursor body to the permanent magnet body. One or more recoil pulses are then applied to the permanent magnet body. The recoil pulse(s) has a second magnitude smaller than the first magnitude of the magnetizing pulses. The recoil pulse(s) has a second direction opposite from the first direction of the magnetizing pulses. As described herein, “second direction opposite from the first direction” means that the second direction differs from the first direction by about 180 degrees (i.e., by exactly 180 degrees or by 180 degrees plus or minus a small unavoidable deviation due to magnetization equipment errors). In a preferred aspect of the second preferred embodiment, the recoil pulse is applied by the same coil 21 as was used to magnetize the precursor body 7, as shown in FIGS. 5 and 6. The same pulsed magnet (i.e., coil 21) may be used to apply the recoil pulse by reversing a polarity of the coil's power supply or by manually reversing the leads from the power supply, after the step of applying a pulsed magnetic field and before the step of providing at least one recoil pulse. However, if desired, a separate recoil pulse coil may be placed around each permanent magnet body to apply the recoil pulse.

According to another preferred aspect of the second preferred embodiment of the present invention, the energy required for magnetization may be reduced by magnetizing the precursor body above room temperature. Thus, the precursor body is heated above room temperature during the step of magnetization. Preferably, the precursor body is heated above room temperature and below the Curie temperature of the permanent magnet material during the step of magnetizing the precursor body. More preferably, the precursor body is heated to a temperature of about 40 to about 200° C. during the step of magnetization. Most preferably, the precursor body is heated to a temperature of about 50 to about 100° C. during the step of magnetization. At higher temperatures, the magnetizing field required to fully saturate the magnetic material is lower (approaching zero just below the Curie temperature). Once saturated at the higher temperature, one characteristic of this type of magnetic material is to stay close to saturation as the temperature is lowered to room temperature, even though this places the material in a numerically higher state of magnetization at the lower temperature (because the saturation magnetization is higher at the lower temperature). Any method of heating the precursor body may be used. For example, the precursor body may be heated by placing a heating tape around the first precursor body and activating the heating tape. The precursor body may be heated by attaching surface heaters the first precursor body and activating the surface heaters. The precursor body may also be heated by directing radiation from a heating lamp on the precursor body.

The permanent magnet body made according to the methods of the preferred embodiments of the present invention is preferably used in a magnet assembly of an imaging system, such as an MRI system. However, the permanent magnet body may be used in other imaging systems, such as in MRT or NMR systems. Alternatively, the permanent magnet body may be used in non-imaging devices, such as in a motor or a generator.

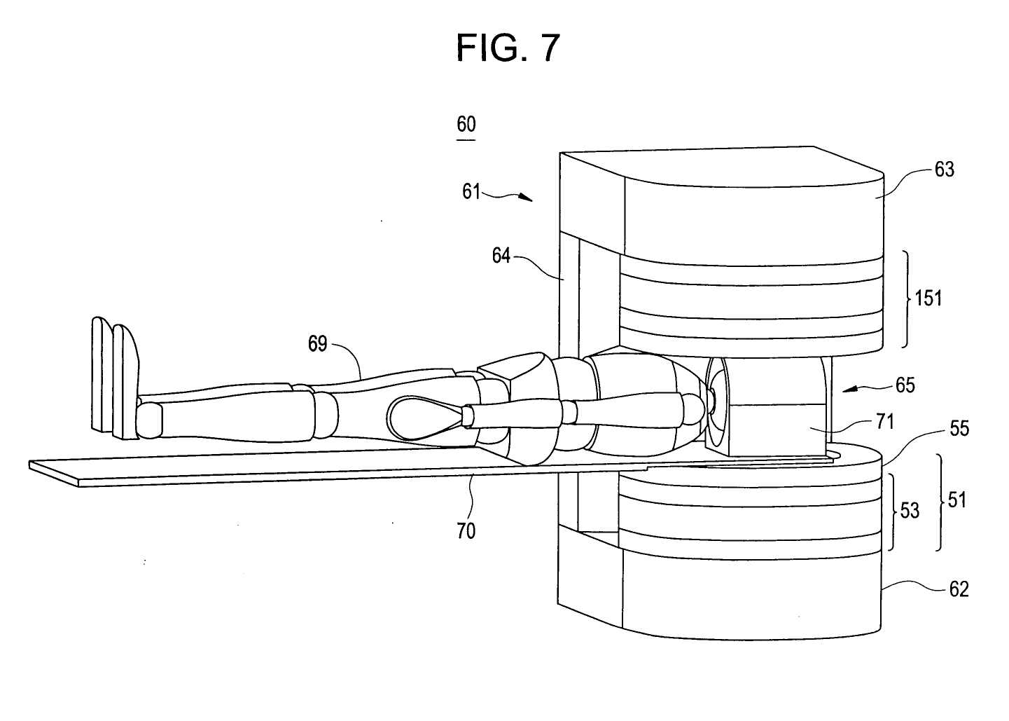

FIGS. 7-9 illustrate preferred MRI systems which contain magnet assemblies 51 which include permanent magnet bodies made by the methods of the preferred embodiments of the present invention. Preferably, at least two magnet assemblies 51 are used in an MRI system 60.

Each magnet assembly 51 preferably contains a permanent magnet body 53 made by the methods of the preferred embodiments of the present invention. Each magnet assembly may also contain an optional pole piece 55, an optional gradient coil (not shown), and RF coil (not shown) and shims (not shown). The magnet assemblies are attached to a yoke or a support 61 in an MRI system. However, if desired, the pole piece and the gradient coil may be omitted, and at least one layer of soft magnetic material may be provided between the yoke and a permanent magnet body having a stepped imaging surface, as disclosed in U.S. Pat. No. 6,518,867, incorporated herein by reference in its entirety. The at least one layer of a soft magnetic material preferably comprises a laminate of Fe—Si, Fe—Al, Fe—Co, Fe—Ni, Fe—Al—Si, Fe—Co—V, Fe—Cr—Ni, or amorphous Fe- or Co-base alloy layers. Thus, the MRI system preferably does not contain a pole piece or a gradient coil between the stepped imaging surface of the permanent magnet body 53 and the imaging volume 65 and between the imaging volume and the stepped imaging surface of the second permanent magnet body 153.

Any appropriately shaped yoke may be used to support the magnet assemblies. For example, a yoke generally contains a first portion, a second portion and at least one third portion connecting the first and the second portion, such that an imaging volume is formed between the first and the second portion. FIG. 7 illustrates a side perspective view of an MRI system 60 according to one preferred aspect of the present invention. The system contains a yoke 61 having a bottom portion or plate 62 which supports the first magnet assembly 51 and a top portion or plate 63 which supports the second magnet assembly 151. It should be understood that “top” and “bottom” are relative terms, since the MRI system 60 may be turned on its side, such that the yoke contains left and right portions rather than top and bottom portions. The imaging volume 65 is located between the magnet assemblies.

The first magnet assembly 51 comprises a first permanent magnet body 53 comprising a rare earth-transition metal-boron alloy, wherein at least 30 weight percent of the rare earth content of the alloy comprises Pr, at least 50 weight percent of the transition metal content comprises Fe, and the alloy contains less than 0.6 weight percent oxygen. The first permanent magnet body 53 has a back surface and a stepped second surface facing the imaging volume, which is shown more clearly in FIG. 4. The least one first layer of soft magnetic material (not shown for clarity in FIG. 7) is located between the first yoke portion 62 and the back surface of the first permanent magnet body 53.

Likewise, the second magnet assembly 151 comprises a second permanent magnet body 153 comprising a rare earth-transition metal-boron alloy, wherein at least 30 weight percent of the rare earth content of the alloy comprises Pr, at least 50 weight percent of the transition metal content comprises Fe, and the alloy contains less than 0.6 weight percent oxygen. The second permanent magnet body 153 has a back surface and a stepped second surface facing the imaging volume. The least one second layer of soft magnetic material (not shown for clarity in FIG. 7) is located between the second yoke portion 63 and the back surface of the first permanent magnet body 153.

The MRI system 60 further contains conventional electronic components, such as an image processor (i.e., a computer), which converts the data/signal from the RF coil into an image and optionally stores, transmits and/or displays the image. FIG. 7 further illustrates various optional features of the MRI system 60. For example, the system 60 may optionally contain a bed or a patient support 70 which supports the patient 69 whose body is being imaged. The system 60 may also optionally contain a restraint 71 which rigidly holds a portion of the patient's body, such as a head, arm or leg, to prevent the patient 69 from moving the body part being imaged. The system 60 may have any desired dimensions. The dimensions of each portion of the system are selected based on the desired magnetic field strength, the type of materials used in constructing the yoke 61 and the assemblies 51, 151 and other design factors.

In one preferred aspect of the present invention, the MRI system 60 contains only one third portion 64 connecting the first 62 and the second 63 portions of the yoke 61. For example, the yoke 61 may have a “C” shaped configuration, as shown in FIG. 7. The “C” shaped yoke 61 has one straight or curved connecting bar or column 64 which connects the bottom 62 and top yoke 63 portions.

In another preferred aspect of the present invention, the MRI system 60 has a different yoke 61 configuration, which contains a plurality of connecting bars or columns 64, as shown in FIG. 8. For example, two, three, four or more connecting bars or columns 64 may connect the yoke portions 62 and 63 which support the magnet assemblies 51, 151.

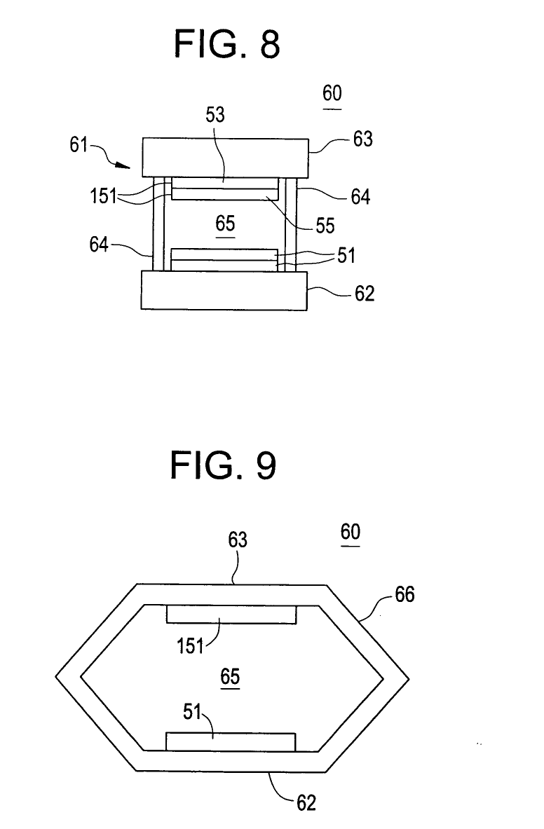

In yet another preferred aspect of the present invention, the yoke 61 comprises a unitary tubular body 66 having a circular or polygonal cross section, such as a hexagonal cross section, as shown in FIG. 9. The first magnet assembly 51 is attached to a first portion 62 of the inner wall of the tubular body 66, while the second magnet assembly 151 is attached to the opposite portion 63 of the inner wall of the tubular body 66 of the yoke 61. If desired, there may be more than two magnet assemblies in attached to the yoke 61. The imaging volume 65 is located in the hollow central portion of the tubular body 66.

The imaging apparatus, such as the MRI 60 containing the permanent magnet assembly 51, is then used to image a portion of a patient's body using magnetic resonance imaging. A patient 69 enters the imaging volume 65 of the MRI system 60, as shown in FIG. 7. A signal from a portion of a patient's 69 body located in the volume 65 is detected by the RF coil, and the detected signal is processed by using the processor, such as a computer. The processing includes converting the data/signal from the RF coil into an image, and optionally storing, transmitting and/or displaying the image.

The following specific examples are presented for illustration purposes only and should not be considered limiting of the scope of the invention. Two alloy blocks are prepared and left in storage in an uncoated state at ambient temperature and atmosphere for about four years. In other words, the alloy blocks are unpainted and not covered with epoxy or other coating during the storage. It is believed that during the storage, the direction of the alloy magnetic domains is random, and the domains cancel each other out. The blocks are visually inspected after four years in storage. No sign of corrosion is detected during visual inspection and the blocks are thus substantially corrosion free after four years in storage. The alloy composition of the blocks contains about 0.12 weight percent oxygen (about 0.048 atomic percent oxygen). The first block contains about 0.125 weight percent oxygen, about 0.0146 weight percent nitrogen and about 0.0455 weight percent carbon. The alloy composition of the second block contains about 0.124 weight percent oxygen, about 0.0150 weight percent nitrogen and about 0.0459 weight percent carbon. The measurement values for the third and fourth decimal points vary somewhat based on experimental conditions.

The average content of the alloying elements in the alloy is provided in the table below in weight and atomic percent. Column 1 provides the element name, column 2 provides the weight percent content of this element, column 3 provides the atomic percent content of this element and column 4 provides the measurement method or methods. The weight percentages have been normalized to 100%.

| Element | Weight % | Atomic % | Measurement Method(s) |
|---|---|---|---|
| Al | 0.42% | 0.99% | Semi-quantitative XRF |
| B | 0.95% | 5.60% | Microwave, Fusion |
| C | 0.044% | 0.233% | Infrared detection |
| Ce | 0.12% | 0.06% | Microwave, Fusion |
| Cl | 0.20% | 0.36% | Semi-quantitative XRF |
| Co | 0.81% | 0.88% | Microwave, Fusion, XRF |
| Dy | 0.56% | 0.22% | Microwave, Fusion |
| Fe | 65.5% | 74.4% | Microwave, Fusion, XRF |
| La | 0.02% | 0.01% | Microwave, Fusion |
| Mg | 0.005% | 0.013% | Microwave, Fusion |
| Mo | 0.01% | 0.00% | Microwave, Fusion |
| N | 0.014% | 0.065% | Thermal conductivity |
| Nd | 7.84% | 3.45% | Microwave, Fusion, XRF |
| O | 0.120% | 0.048% | Infrared detection |
| Pr | 21.6% | 9.7% | Microwave, Fusion, XRF |
| S | 0.04% | 0.08% | Semi-quantitative XRF |
| Si | 1.73% | 3.90% | Semi-quantitative XRF |
| TOTAL | 100% | 100% | |
| Rare earth total | 30.14% | 13.45% | |
| Transition metal total | 66.33% | 75.28% | |
| Boron total | 0.95% | 5.60% | |
| Other elements | 2.57% | 5.68% | |
| % Oxygen | 0.12% | 0.048% | |
| % Pr of total | 71.7% | 72.3% | |
| rare earths | | | |

Thus, as provided in the above table, the alloy composition preferably contains less than 0.5 weight percent Al, less than 0.05 weight percent carbon, less than 0.3 weight percent Cl, less than 2 weight percent Co, a trace amount of Mg, less than 0.2 weight percent Mo, less than 0.02 weight percent nitrogen, less than 0.05 weight percent sulfur and less than 2.5 weight percent Si. Preferably, but not necessarily, these elements are present in the alloy in a non-zero amount. Preferably, the alloy composition contains between about 13 and about 19 atomic percent rare earth elements, of which preferably at least 50 atomic percent and more preferably at least 70 atomic percent comprises Pr and the rest selected from Nd, Ce and optionally La and/or Dy, between about 61 and about 83 atomic percent transition metal elements, of which at least 80 atomic percent and more preferably at least 90 atomic percent comprises Fe and the rest selected from Co, Mo and other transition metal elements, between about 4 and about 20 atomic percent boron, less than 0.08 atomic percent oxygen and less than 7 atomic percent other elements.

The foregoing description of the invention has been presented for purposes of illustration and description. It is not intended to be exhaustive or to limit the invention to the precise form disclosed, and modifications and variations are possible in light of the above teachings or may be acquired from practice of the invention. The drawings and description were chosen in order to explain the principles of the invention and its practical application. It is intended that the scope of the invention be defined by the claims appended hereto, and their equivalents.

1. A composition of matter suitable for use as a permanent magnet comprising a rare earth-transition metal-boron alloy, wherein at least 30 weight percent of the rare earth content of the alloy comprises Pr, at least 50 weight percent of the transition metal content of the alloy comprises Fe, and the alloy contains less than 0.6 weight percent oxygen.

2. The composition of claim 1, wherein the alloy contains greater than zero but less than 0.6 weight percent oxygen.

3. The composition of claim 2, wherein the rare earth-transition metal-boron alloy comprises in atomic percent a RE₁₃₋₁₉ B₄₋₂₀ M₆₁₋₈₃ alloy with the balance impurities and oxygen, where RE is the rare earth and M is the transition metal.

4. The composition of claim 3, wherein the composition comprises a magnetized permanent magnet.

5. The composition of claim 3, wherein the composition comprises an unmagnetized precursor composition which is adapted to be a permanent magnet when magnetized.

6. The composition of claim 3, wherein RE comprises at least 50 atomic percent Pr with an effective amount of Nd and at least one light rare earth element selected from the group consisting of Ce, La, Y and mixtures thereof.

7. The composition of claim 6, wherein the alloy comprises between about 0.1 and about 0.2 weight percent oxygen.

8. The composition of claim 7, wherein:
RE comprises about 50 to about 90 atomic percent Pr, about 9.5 to about 45 atomic percent Nd and about 0.5 to about 5 atomic percent Ce; and
M comprises between about 80 and about 99 atomic percent Fe and between about 0.5 to about 20 atomic percent Co.

9. The composition of claim 8, wherein the alloy is capable of remaining substantially corrosion free for at least four years at atmospheric ambient in an uncoated state.

10. The composition of claim 4, wherein:
M comprises between 75 and 100 atomic Fe; and
the alloy comprises at least 80 weight percent of a RE₂Fe₁₄B phase having a tetragonal crystal structure.

11. The composition of claim 4, wherein the permanent magnet is located in a motor.

12. The composition of claim 4, wherein the permanent magnet is located in a generator.

13. An MRI system comprising a yoke and at least one permanent magnet having a composition of claim 4 attached to the yoke.

14. A magnetic resonance imaging (MRI) system, comprising:
a yoke comprising a first portion, a second portion and at least one third portion connecting the first and the second portion such that an imaging volume is formed between the first and the second yoke portions;
a first magnet assembly attached to the first yoke portion; and
a second magnet assembly attached to the second yoke portion;
wherein the first magnet assembly comprises:
a first permanent magnet body comprising a rare earth-transition metal-boron alloy, wherein at least 30 weight percent of the rare earth content of the alloy comprises Pr, at least 50 weight percent of the transition metal content of the alloy comprises Fe, and the alloy contains less than 0.6 weight percent oxygen, the first permanent magnet body having a first surface and a stepped second surface facing the imaging volume; and
at least one first layer of soft magnetic material located between the first yoke portion and the first surface of the first permanent magnet body.

15. The system of claim 14, further comprising a second magnet assembly attached to the second yoke portion, wherein the second magnet assembly comprises:
a second permanent magnet body comprising a rare earth-transition metal-boron alloy, wherein at least 30 weight percent of the rare earth content of the alloy comprises Pr, at least 50 weight percent of the transition metal content of the alloy comprises Fe, and the alloy contains less than 0.6 weight percent oxygen, the second permanent magnet body having a first surface and a stepped second surface facing the imaging volume; and
at least one second layer of soft magnetic material located between the second yoke portion and the first surface of the second permanent magnet body.

16. The system of claim 15, wherein:
the at least one first layer of a soft magnetic material comprises a first laminate of Fe—Si, Fe—Al, Fe—Co, Fe—Ni, Fe—Al—Si, Fe—Co—V, Fe—Cr—Ni or amorphous Fe- or Co-base alloy layers; and
the at least one second layer of a soft magnetic material comprises a second laminate of Fe—Si, Fe—Al, Fe—Co, Fe—Ni, Fe—Al—Si, Fe—Co—V, Fe—Cr—Ni or amorphous Fe- or Co-base alloy layers.

17. The system of claim 16, wherein the first permanent magnet body comprises:
a base section having a major first surface attached to the at least one first layer of a soft magnetic material; and
a hollow ring section over a second surface of the base section, where the second surface of the base section is opposite to the first surface of the base section.

18. The system of claim 17, wherein:
the system does not contain a pole piece or a gradient coil between the second surface of the first permanent magnet body and the imaging volume and between the imaging volume and the second surface of the second permanent magnet body; and
the system further comprises an RF coil and an image processor.

19. The system of claim 18, wherein:
the rare earth-transition metal-boron alloy in the first and in the second permanent magnet body comprises in atomic percent a RE₁₃₋₁₉B₄₋₂₀M₆₁₋₈₃ alloy with the balance impurities and oxygen, where RE is the rare earth and M is the transition metal; and
the alloy contains greater than zero but less than 0.6 weight percent oxygen.

20. The system of claim 19, wherein:
RE comprises about 50 to about 90 atomic percent Pr, about 10 to about 45 atomic percent Nd and about 0 to about 5 atomic percent Ce;
M comprises between about 80 and about 100 atomic percent Fe and between about 0 to about 20 atomic percent Co; and
the alloy comprises between about 0.1 and about 0.2 weight percent oxygen and at least about 80 weight percent of a RE₂Fe₁₄B phase having a tetragonal crystal structure.

21. A method of making an MRI device, comprising:
providing a yoke comprising a first portion, a second portion and at least one third portion connecting the first and the second portions such that an imaging volume is formed between the first and the second yoke portions;
attaching a first precursor body to the first yoke portion;
attaching a second precursor body to the second yoke portion;
magnetizing the first precursor body to form a first permanent magnet body after the step of attaching the first precursor body; and
magnetizing the second precursor body to form a second permanent magnet body after the step of attaching the second precursor body;
wherein the first and the second precursor bodies comprise a rare earth-transition metal-boron alloy, wherein at least 30 weight percent of the rare earth content of the alloy comprises Pr, at least 50 weight percent of the transition metal content of the alloy comprises Fe, and the alloy contains less than 0.6 weight percent oxygen.

22. The method of claim 21, wherein:
the step of magnetizing the first precursor body comprises placing a coil around the first precursor body; applying a pulsed magnetic field to the first precursor body to form at least one first permanent magnet body; and removing the coil from the first permanent magnet body; and
the step of magnetizing the second precursor body comprises placing a coil around the second precursor body; applying a pulsed magnetic field to the second precursor body to form at least one second permanent magnet body; and removing the coil from around the second permanent magnet body.

23. The method of claim 22, wherein:
the first and the second precursor bodies comprise assemblies of plurality of unmagnetized rare earth-transition metal-boron alloy blocks; and
the pulsed magnetic field comprises a magnetic field of at least 2.5 Tesla.

24. The method of claim 23, further comprising:
placing the plurality of unmagnetized alloy blocks on a support prior to the step of attaching the first precursor body;
placing a cover over the blocks;
shaping the blocks to form the first precursor body prior to removing the cover and the support;
removing the cover from the first precursor body;
providing an adhesive material to adhere the blocks of the first precursor body to each other; and
removing the support from the first precursor body.

25. The method of claim 21, further comprising attaching at least one layer of a soft magnetic material between the first precursor body and the first yoke portion.

26. The method of claim 21, wherein:
the rare earth-transition metal-boron alloy comprises in atomic percent a RE₁₃₋₁₉B₄₋₂₀M₁₁₋₈₃ alloy with the balance impurities and oxygen, where RE is the rare earth and M is the transition metal; and
the alloy contains greater than zero but less than 0.6 weight percent oxygen.

27. The method of claim 26, wherein:
RE comprises about 50 to about 90 atomic percent Pr, about 10 to about 45 atomic percent Nd and about 0 to about 5 atomic percent Ce;
M comprises between about 80 and about 100 atomic percent Fe and between about 0 to about 20 atomic percent Co; and
the alloy comprises between about 0.1 and about 0.2 weight percent oxygen and at least about 80 weight percent of a RE₂Fe₁₄B phase having a tetragonal crystal structure.

28. The method of claim 21, where the step of magnetizing the first precursor body is carried out at a temperature above room temperature.

29. The method of claim 21, further comprising subjecting the first permanent magnet body to a recoil pulse after the step of magnetizing the first precursor body to form the first permanent magnet body.

30. A method of making a permanent magnet comprising:
providing a rare earth-transition metal-boron alloy precursor powder;
compressing the precursor powder into a green body while applying a magnetic field;
compacting and sintering the green body to form a sintered intermetallic block; and
magnetizing the sintered intermetallic block to form a permanent magnet block comprising a rare earth-transition metal-boron alloy, wherein at least 30 weight percent of the rare earth content of the alloy comprises Pr, at least 50 weight percent of the transition metal content of the alloy comprises Fe, and the alloy contains less than 0.6 weight percent oxygen.

31. The method of claim 30, further comprising attaching the permanent magnet block to a yoke portion of an imaging system after the step of magnetizing the sintered intermetallic block.

32. The method of claim 30, further comprising attaching the sintered intermetallic block to a yoke portion of an imaging system prior to the step of magnetizing the sintered intermetallic block.

33. The method of claim 30, wherein the rare earth-transition metal-boron alloy comprises in atomic percent a RE₁₃₋₁₉B₄₋₂₀M₆₁₋₈₃ alloy with the balance impurities and oxygen, where RE is the rare earth, M is the transition metal, and the alloy contains greater than zero but less than 0.6 weight percent oxygen.

34. A method of making a motor or a generator device, comprising:
providing a motor or a generator device;
attaching a first precursor body comprising at least one unmagnetized alloy block to the device; and
magnetizing the at least one unmagnetized alloy block to form a first permanent magnet body after the step of attaching the first precursor body.

35. The method of claim 34, wherein the at least one unmagnetized alloy block comprise a rare earth-transition metal-boron alloy, wherein at least 30 weight percent of the rare earth content of the alloy comprises Pr, at least 50 weight percent of the transition metal content of the alloy comprises Fe, and the alloy contains less than 0.6 weight percent oxygen.

36. The method of claim 34, wherein the device is a motor.

37. The method of claim 34, wherein the device is a generator.
